(19) United States
(12) Patent Application Publication
(10) Pub. No.: US 2019/0226935 A1
(43) Pub. Date: Jul. 25, 2019

(54) Low Frequency Pressure Sensing

(71) Applicant: Watasensor, Inc., San Jose, CA (US)

(72) Inventors: George Fuh Hwang, San Jose, CA (US); Kajiro Watanabe, Tokyo (JP); Danh Le Ngoc, Saratoga, CA (US)

(21) Appl. No.: 15/878,274

(22) Filed: Jan. 23, 2018

(51) Int. Cl. G01L 19/00

(52) U.S. Cl. CPC G01L 19/00

(57) ABSTRACT

Embodiments of the present disclosure pertain to low frequency pressure sensing. In one embodiment, the present disclosure includes an apparatus comprising a pressure sensor having at least one input and a chamber. The chamber is coupled to the input of the pressure sensor to control pressure variations sensed by the pressure sensor. The chamber comprises a hole, where the hole and the chamber are configured to low pass filter pressure variations at the input of the pressure sensor and filter out pressure variations above about 20 hertz.

### BACKGROUND

The present disclosure relates to pressure sensing, and in particular, to low frequency pressure sensing.

The most common pressure sensor devices are audio pressure sensors (e.g., audio microphones). Audio pressure sensors detect changes in air pressure within the audio range of about 20 hertz (Hz) to 20,000 kHz. However, accurately sensing pressure changes having frequencies below the audio range with high signal to noise ratios (S/N) can be technically challenging. The most common types of audio pressure sensors (e.g., microphones) are not typically designed to accurately sense frequencies below about 20 Hz. At very low frequencies, noise in the system may impede the accuracy of pressure measurements. Electronic processing and removal of noise may be insufficient to obtain pressure measurements with enough accuracy for some applications at very low frequencies.

### SUMMARY

Embodiments of the present disclosure pertain to low frequency pressure sensing. In one embodiment, the present disclosure includes an apparatus comprising a pressure sensor having at least one input and a chamber. The chamber is coupled to the input of the pressure sensor to control pressure variations sensed by the pressure sensor. The chamber comprises a hole, where the hole and the chamber are configured to low pass filter pressure variations at the input of the pressure sensor and filter out pressure variations above about 20 hertz.

In one embodiment, the hole and the chamber are configured to low pass filter pressure variations at the input of the pressure sensor and filter out pressure variations above about 10 Hz and/or below about 0.1 Hz, for example. In one embodiment, the low pass filter filters out frequencies above an upper frequency of a frequency range of an event, and further may filter frequencies below a lower frequency of the frequency range of the event, for example.

In one embodiment, the pressure sensor comprises a first input and a second input, wherein the chamber is a first chamber and the hole is a first hole, and further comprising a second chamber coupled to a second input of the pressure sensor, the second chamber comprising a second hole, wherein the second hole and the second chamber combine with the first chamber and the first hole to band pass filter pressure variations at the input of the pressure sensor and filter out pressure variations above about 20 hertz and below 0.1 Hz.

The following detailed description and accompanying drawings provide a better understanding of the nature and advantages of the present disclosure.

### BRIEF DESCRIPTION OF THE DRAWINGS

FIG. 1 illustrates low frequency pressure sensing according to one embodiment.

FIG. 2 illustrates a chamber for low frequency pressure sensing according to one embodiment.

FIG. 3A illustrates a chamber with an encapsulated pressure sensor according to one embodiment.

FIG. 3B illustrates a chamber attached to a pressure sensor according to one embodiment.

FIG. 4A illustrates chamber hole according to one embodiment.

FIG. 4B illustrates chamber hole according to another embodiment.

FIG. 4C illustrates a chamber sidewall and pipe extender according to one embodiment.

FIG. 4D illustrates a chamber sidewall and pipe extender according to another embodiment.

FIG. 5 illustrates a low frequency pressure sensor according to another embodiment.

FIG. 6 illustrates chamber attached to a pressure sensor according to another embodiment.

FIG. 7 illustrates differential pressure sensing according to another embodiment.

FIG. 8 illustrates a frequency response for differential pressure sensing according to another embodiment.

FIG. 9 illustrates shielding an input of a chamber according to another embodiment.

FIG. 10 illustrates a differential pressure sensor with shielding according to another embodiment.

FIG. 11 illustrates a pressure sensor system according to another embodiment.

FIG. 12 illustrates a programmable pressure sensor according to another embodiment.

FIG. 13 illustrates another embodiment of the present disclosure.

FIG. 14 illustrates an application of pressure sensing to event detection according to another embodiment.

FIG. 15 illustrates a model for event detection according to another embodiment.

FIG. 16A illustrates a view of a case according to an embodiment.

FIG. 16B illustrates a view of a case according to an embodiment.

FIG. 16C illustrates a view of a case according to an embodiment.

FIG. 17 illustrates a view of a case according to an embodiment.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

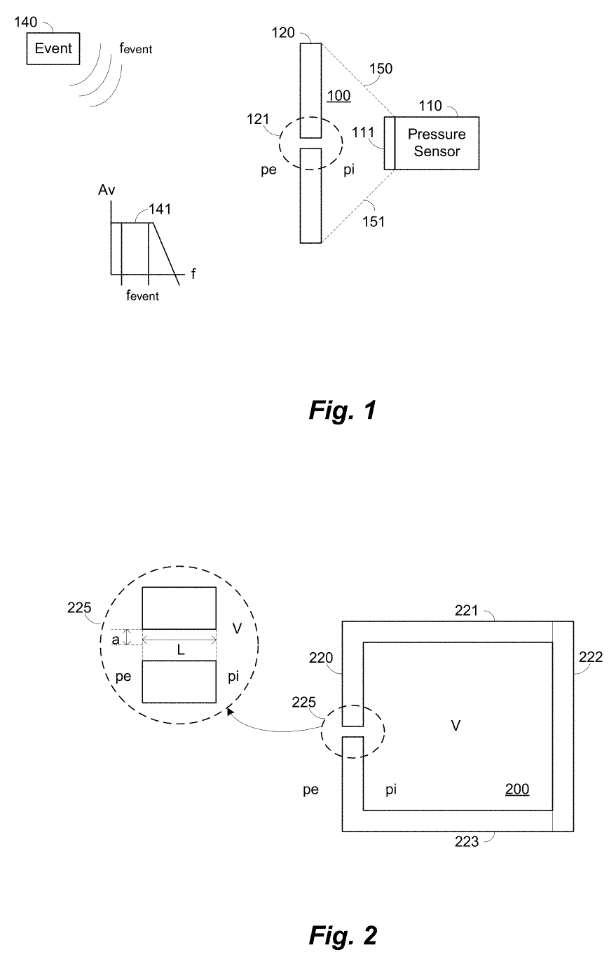

FIG. 1 illustrates low frequency pressure sensing according to one embodiment. Embodiments of the present disclosure include one or more pressure sensors 110 having at least one pressure sensing input 111. Features and advantages of the present disclosure include establishing a chamber 100 around input 111 of pressure sensor 110 to control pressure variations at the input of the pressure sensor. As illustrated, in FIG. 1, there may be an external pressure, pe, on one side of a chamber sidewall 120 and an internal pressure, pi, internal to the chamber 100. Chamber 100 may define an enclosed space of any shape, for example, separating internal pressure, pi, from external pressure, pe (here, represented by dashed lines 150 and 151). Chamber 100 may have one or more sidewalls. A portion of one sidewall 120 is shown here for illustrative purposes. Chamber 100 may comprise a hole as illustrated at 121, wherein the hole and the chamber are configured to low pass filter pressure variations at the input of the pressure sensor and filter out pressure variations above about 10 Hertz (below the audio range of about 20 kHz). In some embodiments, the hole may be a single hole and may be circular or have another cross sectional shape, for example. As illustrated in the examples below, the chamber may be integrated with (e.g., attached to) the pressure sensor or, in other example embodiments, the chamber may encapsulate the pressure sensor, for example. Further, while some examples disclosed herein illustrate various embodiments with a “single” hole in the chamber, other embodiments may have multiple holes. If there multiple holes, they may be equivalent to a single hole, but with a wider cross-sectional area, for example.

FIG. 1 further illustrates that the dimensions of the chamber and hole may be configured to detect a particular low frequency event 140. Event 140 may be any of a variety of events that generate a low frequency pressure (e.g., below about 20 Hertz). According to various embodiments, the dimensions of the chamber and hole may implement a low pass filter 141 or even a high pass filter (described below), wherein the radius and the length of the hole 121 and the volume of the chamber 100 are configured to program a frequency pass band of the low pass filter 141 to include at least one target event generating a particular low pressure frequency signal, for example. As illustrated in FIG. 1, a low pass filter created by hole 121 has a pass band where the transfer function (Av=Vo/Vin) includes fevent, the frequency of event 140, for example. Hole 121 causes the transfer function Av to drop above a cutoff frequency (described in more detail below, so that frequencies above the cutoff frequency are more attenuated (reduced in strength) than the target event frequency. Accordingly, the noise caused by frequencies other than the target event frequency is reduced.

FIG. 2 illustrates a chamber for low frequency pressure sensing according to one embodiment. In one embodiment, the chamber 200 includes a hole 225, where a radius (a) of the hole, a length (L) of the hole, and a volume (V) of the chamber set a low pass filter frequency of pressure variations at the input of the pressure sensor. For example, FIG. 2 illustrates a chamber 200, comprising a plurality of sidewalls 220-223 and a hole 225 in sidewall 220, for example. It is to be understood that a variety of shapes and geometries may be used to form chamber 200. The shape shown in FIG. 2 is merely illustrative. In this example, hole 225 forms a pipe having an approximately constant diameter (i.e., twice the radius, or d=2*a), and a length of the hole is greater than the diameter of the hole. As illustrated below, a pipe may be formed in a variety of ways, such as sidewalls of a hole, extenders, or a flexible tube, for example. In this example, an internal pressure (pi) of the chamber and an external pressure (pe) are coupled together only through the hole 225. Accordingly, chamber 200 may be substantially airtight except for the single hole 225, for example. Configured in this manner, hole 225 forms a low pass filter which can control pressure variations at the input of the pressure sensor anywhere inside the chamber.

Using hole 225 to produce pneumatic low-pass filtering, pressure changes occurring at frequencies below a cutoff frequency are passed and frequencies above the cutoff frequency are attenuated (cut off). In the pneumatic filtering, gas pressure (e.g., air pressure) is filtered instead of voltage, where voltage is the typical case when using an electric filter circuit after a pressure sensor. Generally, noise in a signal is reduced by moving noise reduction mechanisms closer to the signal source. Thus, implementing the filter on the pressure signals before conversion and processing to noisy electric signals advantageously reduces noise in the signal. More specifically, use of a pneumatic filter is more effective than the electric filter because it cuts the low frequency noise pressure off before arriving at an input of a pressure sensor and any electronic amplifier after the sensor, and may further avoid saturation of the pressure sensor and the circuit, for example. The cutoff frequency f_{c} of a pneumatic low pass filter created by hole 225 is given as follows:

$${f}_{c} = \frac{1}{2 π \frac{rVn}{RT}}$$

The coefficients n, R and T are physical constants which are not changeable but the coefficients r and V are changeable. In the cutoff frequency equation above, the coefficient V is the volume of the chamber and r is the flow resistance determined by the Hargen-Poiseuille law as follows:

$$r = \frac{8 η ρ L}{π {a}^{4}}$$

In this example, ρ is the density of air (physical constant), η is the viscosity of air (physical constant), L is the length of hole 225 and α is the radius of the leak. Mathematically, the cut-off frequency is described as follow;

$${f}_{c} = \frac{1}{2 π \frac{\frac{8 η ρ L}{π {a}^{4}} Vn}{RT}} = \frac{RT}{2 π \frac{8 η ρ L}{π {a}^{4}} Vn} = \frac{RT {a}^{4}}{16 η ρ nLV} = \frac{RT}{16 η ρ n} \cdot \frac{{a}^{4}}{LV}$$

Accordingly, the cut-off frequency is proportional to α⁴ and a function of the length L of hole 225 and the volume V of chamber 200.

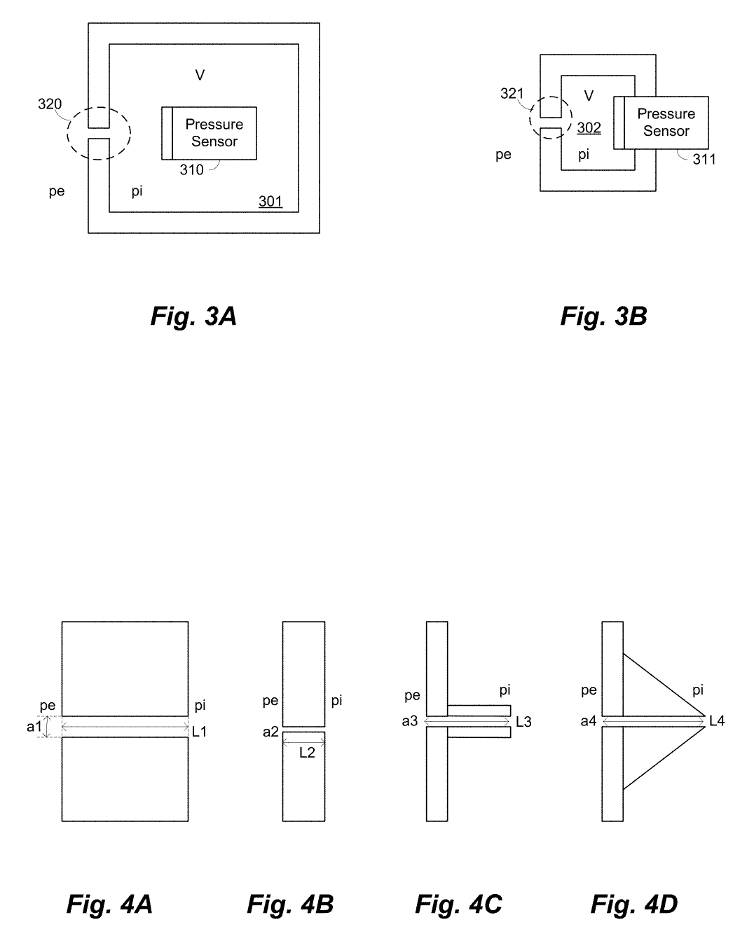

FIGS. 3A-B illustrates example alternative approaches for establishing a chamber around an input to a pressure sensor. In FIG. 3A, a chamber 301 including a hole 320 has a pressure sensor 310 encapsulated inside the chamber. Accordingly, the internal pressure is surrounded by a filtered internal pressure, pi. Alternatively, FIG. 3B illustrates a chamber 302 including a hole 321 where the chamber is attached to the pressure sensor 311 such that the input of the pressure sensor is exposed to a filtered internal pressure, pi. Further example implementations of these two embodiments are described in more detail below.

FIGS. 4A-D illustrate example alternative approaches for chamber sidewalls and pipe extenders according to various embodiments. FIG. 4A illustrates an embodiment where a sidewall of a chamber acts as a pressure frequency low pass filter. In FIG. 4B, the thickness of the sidewall is decreased, thereby reducing the radius, a, of the hole. Accordingly, the length of the hole may also be reduced (e.g., if the thickness of the sidewall is thin, a relatively smaller hole may be drilled by a machine tool like as a laser beam machine). Comparing FIGS. 4A and 4B, L1>L2 and a1>a2. However, since the radius varies to the power of 4, a reduction in length may require a large reduction in radius (root 4). Thus, features and advantages of some embodiments may include pipe extenders coupled to the sidewalls to extend the length of the hole for more effective filtering for a given hole radius. FIGS. 4C-D illustrate example pipe extenders. For example, a hole may be formed in a first sidewall of the chamber, and the first sidewall a pipe extender extending from the first sidewall of the chamber to increase a length of the hole. In FIGS. 4C-D, the radius a3 and a4 may require a length L that would result in a thick and potentially costly and undesirable sidewall for the chamber. Accordingly, pipe extenders 401 and 402 are attached to the sidewalls to extend the length of the hole to provide the desired low pass filter characteristics. In the example of FIG. 4C, the pipe extenders are rectangular, and in the example of FIG. 4D the pipe extenders are triangular. It is to be understood that a wide range of other shapes could also be used in other implementations and that the example shown here are merely illustrative.

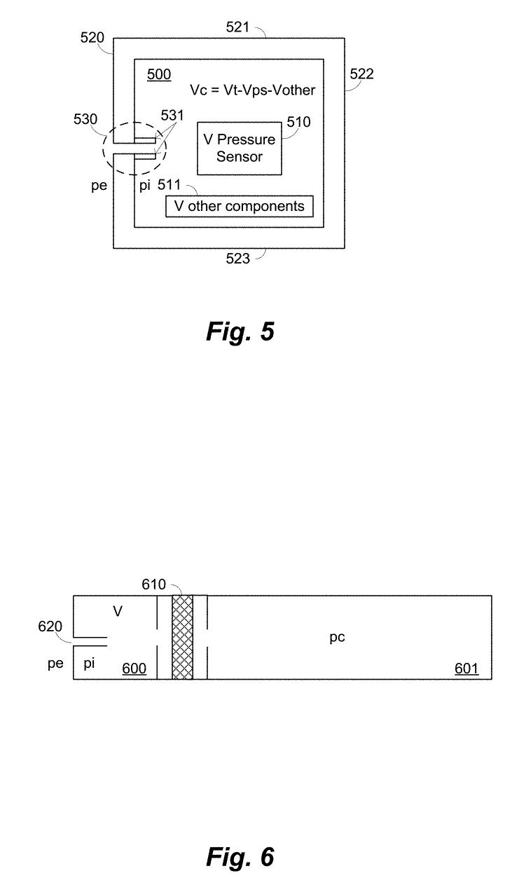

FIG. 5 illustrates a low frequency pressure sensor according to another embodiment. In this example, a pressure sensor 510 is fully encapsulated inside chamber 500 having sidewalls 520-523 and a single hole 530 with pipe extenders 531 to filter pressure above a particular cutoff frequency, for example. Chamber 500 may have additional sidewalls (not shown) so that chamber 500 is fully enclosed by 6 sidewalls, for example. In some embodiments, the volume (V) inside chamber 500 may be occupied by various system components, such as pressure sensor 510 and other components 511 (e.g., PCB circuit boards, capacitors, inductors, integrated circuit packages, wires, or interconnects). Accordingly, the volume used to set the low pass frequency of hole 530, extended by pipe extenders 531, is modified. If the total volume of the chamber is Vt, the volume of the pressure sensor is Vps, and the volume of the other components is Vother, then the cutoff frequency of the hole corresponds to a remaining chamber volume (Vc) equal to the total volume (Vt) less the volume of the pressure sensor and the volume of other components (i.e., Vc=Vt−Vps−Vother), for example. More generally, the chamber volume may be set at total volume less the volume of components that occupy space in the chamber, for example.

FIG. 6 illustrates chamber attached to a pressure sensor according to another embodiment. In this example embodiment, a chamber 600 including a pipe extended hole 620 is attached to a pressure sensor 610. One input of pressure sensor 610 (e.g., a front port) may be coupled to chamber 600 and an opposite input (e.g., a rear port) may be coupled to a closed chamber 601 having a constant pressure pc to separate one side of the pressure sensor from open space, for example. In one embodiment, the pressure sensor 610 may be a microphone comprising an electret film, for example. Accordingly, chamber 600 may advantageously change a directional microphone to an ultra-high gain, low noise, and ultra-low frequency pressure sensor with integrated pneumatic low pass filtering, for example. Embodiments such as illustrated in FIG. 4 may provide more compact and smaller solutions that may be advantageous in certain applications.

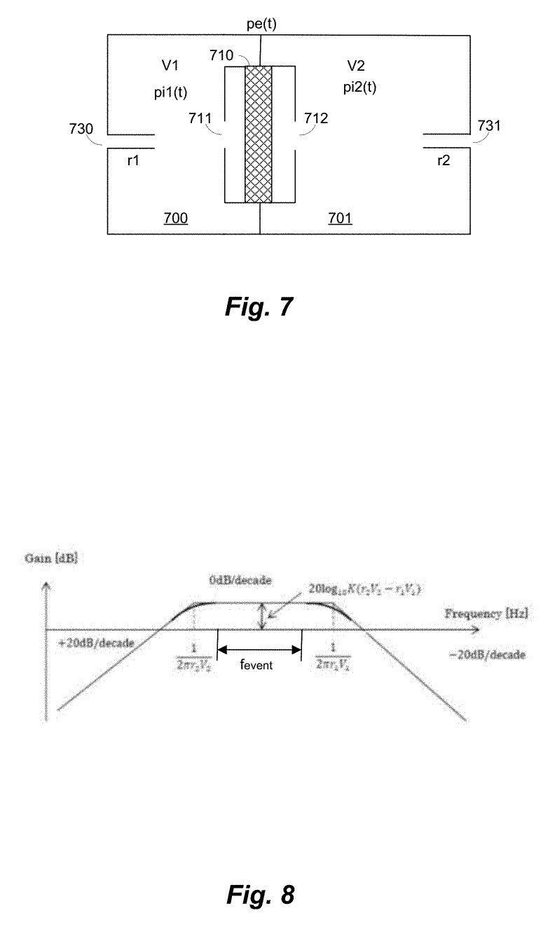

FIGS. 7-8 illustrate differential pressure sensing according to another embodiment. FIG. 7 shows the structure of a pneumatic band bass filter pressure sensor. In one embodiment, a pressure sensor 710 may have two inputs (e.g., differential inputs) 711 and 712, for example. Sensor input 711 (left port) is coupled to chamber 700 to control pressure variations at the input 711 of pressure sensor 710. Chamber 700 has a hole 730 configured to low pass filter pressure variations received at input 711. Similarly, sensor input 712 (right port) is coupled to chamber 701 to control pressure variations at the input 712 of pressure sensor 710. Chamber 701 has a hole 731 configured to low pass filter pressure variations received at input 712.

The configuration illustrated in FIG. 7 implements a band pass filter. For example, the external pressure is pe(t), the internal pressure in chamber 700 attached to input 711 of pressure sensor 710 is pi1(t), and the volume and flow resistance of hole (or orifice) 730 are V1 and r1, respectively, where flow resistance is a function of radius and length of the orifice. Similarly, the internal pressure in chamber 701 attached to input 712 of pressure sensor 710 is pi2(t), and the volume and flow resistance of hole (or orifice) 731 are V2 and r2, respectively. Accordingly, the transfer functions from pe(t) to pi1(t) and that from pe(t) to pi2(t) are two low pass filters as follows:

$$\frac{1}{1 + sr 1 V 1}$$

$$\frac{1}{1 + sr 2 V 2}$$

In this example, pressure sensor 710 is differential, such as in a directional condenser microphone. For differential pressures acting on the left port and right port, output voltage is as follows:

$$E ( t ) = K ( \frac{1}{1 + sr 1 V 1} - \frac{1}{1 + sr 2 V 2} ) pe ( t )$$

For r2V2>r1V1, the frequency response is a band pass filter as illustrated in FIG. 8. In some example applications, the frequency ranges of certain security events are low, approximately between 1 Hz to 10 Hz. As described in more detail below, some event frequencies may be lower than 1 Hz, such as a tornado or earthquake, for example. Thus, by setting the corner frequency of low pass filter 730 to 10 Hz, for example, and the corner frequency of filter 731 to 1 Hz, for example (or lower as desired for a particular event), a band pass system between 1 Hz to 10 Hz may be obtained.

Note there are a variety of alternative shapes and structures that have the same function as the structure shown in FIG. 7 and that realize the frequency response shown in FIG. 8. The structure in FIG. 7 is one example to explain the basic principle of the pneumatic band-pass filter. Other shapes of chambers with volumes V1 and V2 and other shapes of the hole/orifice having flow resistance r1 or r2 will also produce band pass behavior described herein.

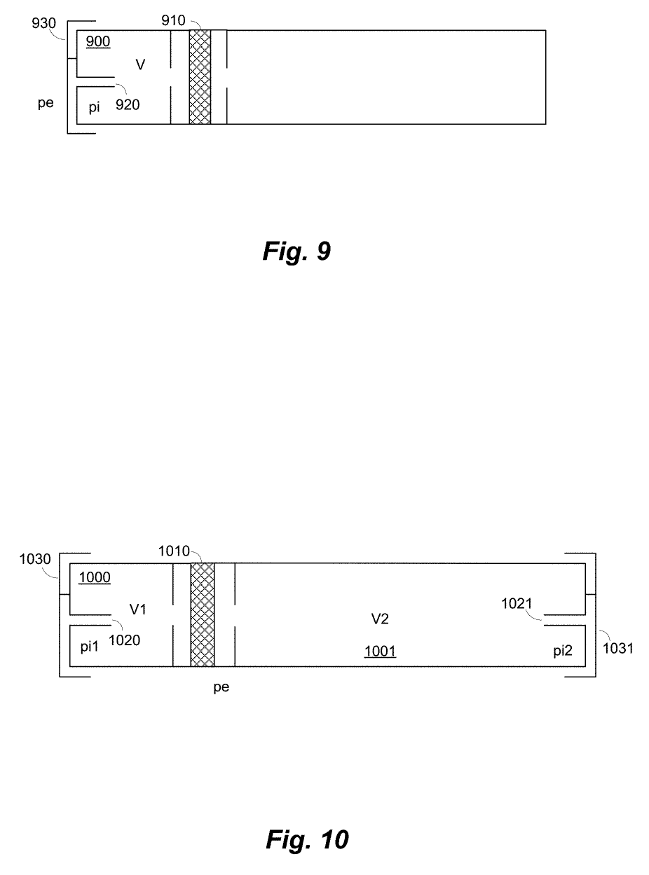

FIG. 9 illustrates shielding an input of a chamber according to another embodiment. Features and advantages of some embodiments may include a shield to reduce noise coupled to the input of a pressure sensor, such as from dynamic pressure caused by turbulent flow of wind, for example. In this example, pressure received by pressure sensor 910 is controlled by chamber 900 having a hole 920 with pipe extenders. Advantageously, a shield 930 is placed outside chamber 900 to cover hole 920. Shield 930 may reduce noise at the input of hole 920 from, for example, wind or other dynamic pressure disturbances that are outside the frequencies of interest. While the gap between the shield and the hole should generally be small, actual dimensions of the pneumatic filter (the radius and length of the hole, and the volume of the enclosure) and the gap should be determined by the size of the final product as well as the performance targets.

FIG. 10 illustrates a differential pressure sensor with shielding according to another embodiment. In this example, pressure sensor 1010 and chambers 1000 and 1001 having filter holes 1030 and 1031 form a pneumatic band bass filter. For instance, pressure variations in chamber 1000 are shielded by a first shield 1030 before being low pass filtered by hole 1020. Similarly, pressure variations in chamber 1001 are shielded by a second shield 1031 before being low pass filtered by hole 1021. The sensor shown in FIG. 10 may detects pressure events without disturbances by acoustic noises and other pressure changing noises as well as the noise from wind.

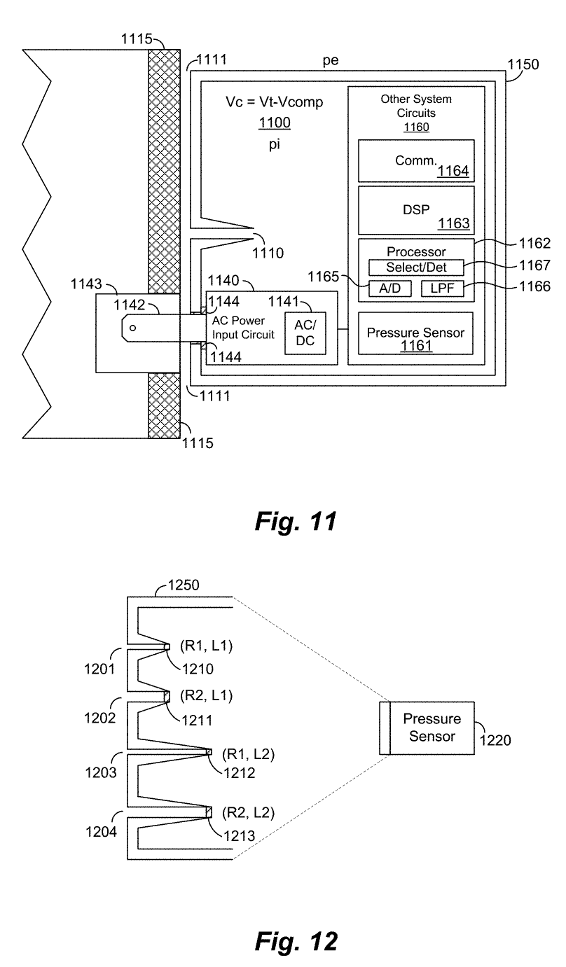

FIG. 11 illustrates a pressure sensor system according to another embodiment. Features and advantages of some embodiments of the present disclosure include a system for sensing low frequency pressure variations and detecting one or more events. For example, opening/closing doors, broken windows, fire, and a range of other events may be detected using a low frequency pressure sensing system illustrated in FIG. 11. In this example, sidewalls of a case 1150 (e.g., a plastic case or housing) may form a chamber 1100 that is substantially airtight except only for a single hole 1110 including pipe extenders to form a low pass pressure filter between an external pressure, pe, and an internal pressure, pi.

A variety of electrical components may be included inside case 1150 to provide power, sensing, and processing, for example. In this example, electrical power is received over an AC power input circuit 1140, which includes an AC wall plug 1142 (“prongs”) that plugs into a wall outlet 1143 to receive AC power (e.g., 110V in the US or 220V in some other countries). AC power input circuit 1140 includes an AC to DC power converter 1141 to transform AC voltage and current into DC voltage and current, for example. DC power may be provided to other system circuits 1160, which may include a pressure sensor 1161, processor (e.g., microcontroller, uC, or microprocessor, uP) 1162, digital signal processor (DSP) 1163, and communication interface circuits 1164.

During operation, low frequency pressure signals are low pass filtered as they pass through extended hole 1110 into chamber 1100. In this example, the hole 1110 is configured on the same sidewall as the AC plug 1142 so that an external surface (e.g., a wall 1115) is adjacent to a distal end of the hole (e.g., the side of the hole flush with the case) when the AC plug is inserted into an AC power outlet and a shield (as described above) is formed in a gap 1111 between a sidewall of the case 1150 and wall 1115, for example. In this example, chamber 1100 inside case 1150 is substantially airtight except for the single hole 1110. For example, the area between the case 1150 and AC wall plugs 1142 may be sealed with a sealant 1144 to ensure that the only way changes in external pressure, pe, may enter chamber 1100 and impact internal pressure, pi, is through extended hole 1110.

Pressure sensor 1161 and other electronic components receive power from AC power input circuit 1140 and receive low frequency filtered pressure signals inside chamber 1100. Low frequency filtered pressure signals below about 20 Hz are converted to an electrical signal by pressure sensor 1161. These electrical signals are then converted to digital signals by analog-to-digital converter 1165, for example. Additional electrical low pass filtering 1166 may be performed digitally by processor 1162. The digitized low frequency pressure signals may then be sent to DSP 1163 to detect low pressure events as described in more detail below, for example. Results of the event detection may be communicated externally using communications circuits 1164, which may include wireless communications (e.g., Bluetooth) in some embodiments or wireline communications (e.g., data over AC powerline) in other embodiments, for example.

FIG. 12 illustrates a programmable pressure sensor according to another embodiment. In some embodiments, a chamber 1250 may comprise a plurality of holes 1201-1204 having different lengths or different cross sectional areas, or both, to produce different low pass filter bandwidths for controlling low frequency pressure signals at an input of pressure sensor 1220, for example. Each hole may have a cover 1210-1213 so that the chamber is airtight, for example. A single hole may be opened (uncovered) while other holes remain covered, for example, such that the uncovered hole produces a particular low pass filter bandwidth corresponding to a length and a cross sectional area of the uncovered single hole. FIG. 12 illustrates four holes 1201-1203 having covers 1210-1213, respectively. As mentioned above, holes may be circular or have other cross sectional shapes. In this example, the four holes have different cross sections (e.g., radius) or different lengths. For illustrative purposes, hole 1201 has a radius R1 and length L1, hole 1202 has a radius R2 and length L1, hole 1203 has a radius R1 and length L2, and hole 1204 has a radius R2 and length L2. In other embodiments, different holes may have different lengths and the same radius, or different radii and the same length, for example, configured to maintain low pass filter functionality. Initially, all the holes may be covered holes (e.g., during manufacturing). Later, only a single hole is opened to produce a particular low pass filter bandwidth corresponding to a length and a cross sectional area of the single hole. The holes are programmable in the sense that a particular type of event may generate a particular low pressure frequency signal (or signals within a particular low frequency range). Different holes may be uncovered to produce an uncovered hole to program a frequency band of the low pass filter to fit at least one target event generating a particular low pressure frequency signal, for example.

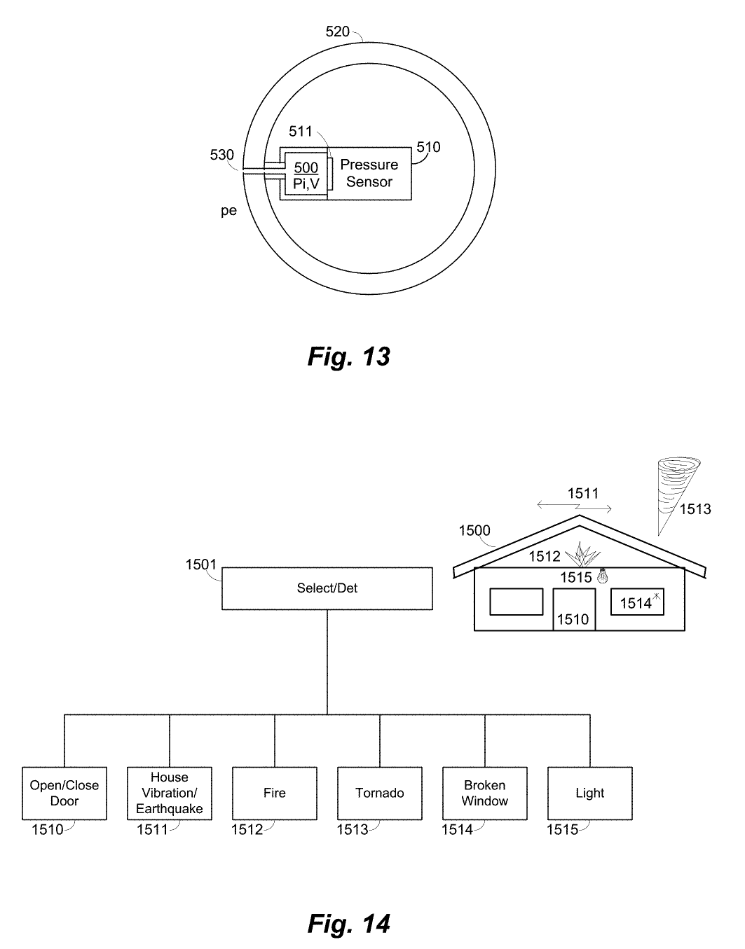

FIG. 13 illustrates another embodiment of the present disclosure. This example illustrates various alternative embodiments. For instance, this example illustrates that the chamber 500 may be defined independently of the case 520. Also, the chamber or the case, or both, may be curved or take on a variety of shapes, for example. Here, a curved case 520 includes low pass filter hole 530 to an airtight internal chamber 500 to control pressure variations at an input 511 of a pressure sensor 510. While pressure in this example may be air pressure, it is to be understood that other gas pressures may be sensed in different embodiments. Yet other embodiments may sense low frequency pressure variations of liquids, for example.

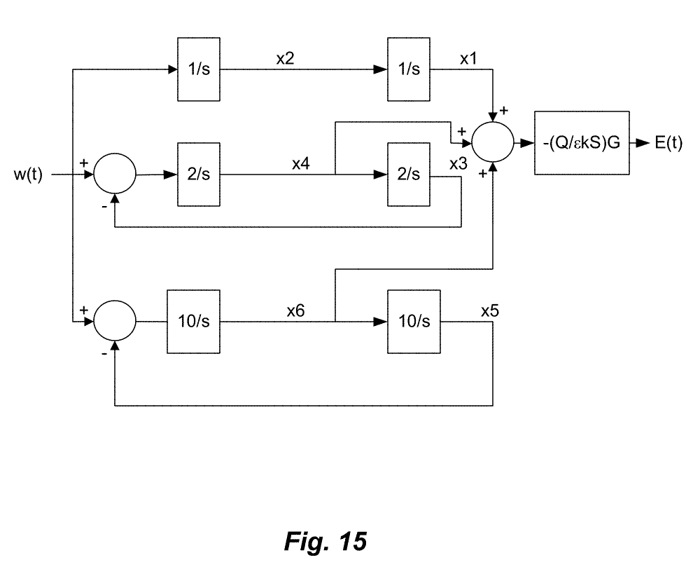

FIG. 14 illustrates an application of pressure sensing to event detection according to another embodiment. As mentioned above, low frequency pressure sensing may be used to detect a variety of low frequency pressure related events. In this example, the low pass filter is set to a frequency range to detect opening and/or closing of doors, house vibrations such as earthquakes, fires, tornados, broken windows, or a light turning on. Each of these events has a known or characterized infrasonic sound profile that can be detected by sensing low pressure variations below 20 Hz, for example. One example algorithm for processing low frequency pressure to detect different events is shown in FIG. 15. FIG. 15 shows the simplified disaster-sensing model. The application of Kalman filtering under the model in FIG. 15 provides estimates of the state variables x1(t), x2(t), x3(t), x4(t), x5(t), and x6(t) in FIG. 15. The variables {x1(t), x2(t)} are associated with (1) a fire disaster. The variables {x3(t), x4(t)} are associated with (1) a fire disaster, (2) door opening and closing, (3) lights being turned on and off, and (4) an earthquake. The variables {x5(t), x6(t)} are associated with (1) unlocking a locked door and (2) vibration of the house caused by an earthquake. If changes in the pair of state variables are observed or exceed certain thresholds, the states are ON; otherwise, the states are OFF. From the aforementioned discussion, we can generate a decision table, as shown in Table 1. The above processing may be implemented in a DSP as part of a system as described above, for example.

TABLE 1

| Estimated State Variables | | | |
|---|---|---|---|
| x1, x2 | x3, x4 | x5, x6 | Decision |
| ON | ON | OFF | Fire |
| OFF | OFF | ON | Unlocking |
| OFF | ON | OFF | Opening/closing |
| | | | door or light on |
| ON | OFF | ON | Earthquake |
| OFF | OFF | OFF | None |

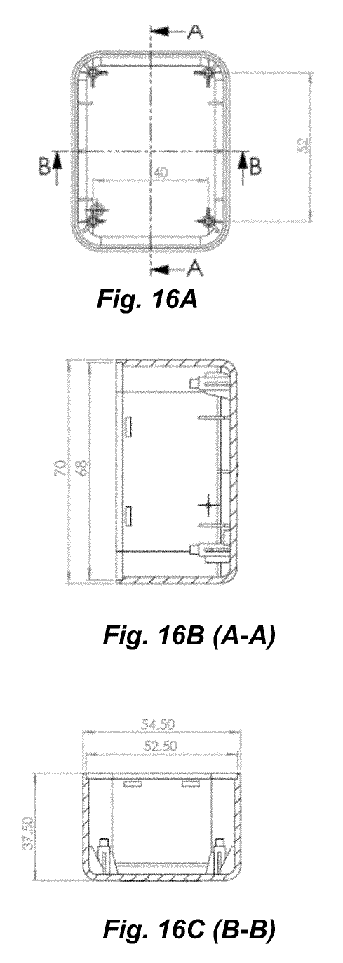

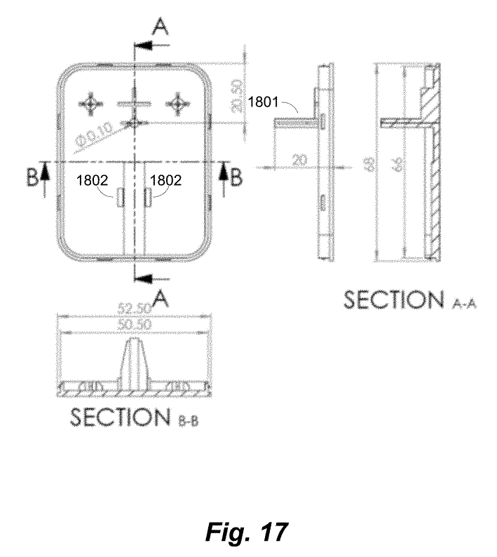

FIGS. 16A-C and FIG. 17 illustrate an example case according to another embodiment. FIGS. 16A-C illustrate the front part of a case or enclosure, and FIG. 17 illustrates the back side of the case or enclosure. FIG. 17 illustrates pipe extenders 1801 and holes for AC wall plugs/prongs 1802, which are sealed when the system is fully assembled.

Table 2 below shows the detailed calculation of the cut-off frequency of an example pneumatic low-pass filter achieved via the special enclosure design in FIGS. 16 and 17.

TABLE 2

| | |
|---|---|
| Volume: V | |
| Empty enclosure | |
| Height [mm] | 68 |
| Width [mm] | 55 |
| Depth [mm] | 40 |
| Volume: Ve [mm³] | Ve = 68 × 55 × 40 = 149600 |
| USB charger | |
| Height [mm] | 32 |
| Width [mm] | 32 |
| Depth [mm] | 32 |
| Volume: Vusb [mm³] | Vusb = 32 × 32 × 32 = 32768 |
| Effective Volume: V [mm³] | V = 149600 − 32768 = 116832 |
| Cross section: S | |
| Radius of the hole [mm] | 0.1 |
| S [mm²] | S = πr² = 0.000000031415920 |
| Length: L | Thickness of the back part of the enclosure |
| L [mm] | 0.3 |
| Cutoff frequency | |
| ${f}_{c} = 6.02 \times {10}^{4} \cdot \frac{1}{{V}^{2}} \cdot \frac{{S}^{2}}{L}$ | ${f}_{c} [ Hz ] = 6.02 \times {10}^{4} \cdot \frac{1}{{V}^{2}} \cdot \frac{{S}^{2}}{L} = 6.02 \times {10}^{4} \cdot \frac{1}{{( 0.00011683200000 )}^{2}} \cdot \frac{{( 0.000000031415920 )}^{2}}{0.003000000000000} = 1.450945$ |

The location of the pin hole with the diameter of 0.1. mm is physically located in the back side of the sealed enclosure in this example. The leak hole is well hidden and well protected from the turbulent pressure change due to dynamic pressure by the air flow by such as the wind, when the device in plugged into a power outlet.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. An apparatus comprising:
a pressure sensor having at least one input; and
a chamber coupled to the input of the pressure sensor to control pressure variations sensed by the pressure sensor, the chamber comprising a hole, wherein the hole and the chamber are configured to low pass filter pressure variations at the input of the pressure sensor and filter out pressure variations above about 20 hertz.

2. The apparatus of claim 1 wherein the chamber is coupled to the input of the pressure sensor to control pressure variations at the input of the pressure sensor.

3. The apparatus of claim 1 wherein a radius of the hole, a length of the hole, and a volume of the chamber set a low pass filter frequency of pressure variations at the input of the pressure sensor.

4. The apparatus of claim 2 wherein the radius, the length, and the volume are configured to program a frequency pass band of the low pass filter to include at least one target event generating a particular low pressure frequency signal.

5. The apparatus of claim 1 wherein the hole forms a pipe having an approximately constant diameter, and wherein a length of the hole is greater than the diameter of the hole.

6. The apparatus of claim 1 wherein the hole is a single hole in the chamber, and wherein an internal pressure of the chamber and an external pressure are coupled together only through the single hole.

7. The apparatus of claim 1 wherein the pressure sensor is an air pressure sensor.

8. The apparatus of claim 1 wherein the pressure sensor is a liquid pressure sensor.

9. The apparatus of claim 1 wherein the pressure sensor is encapsulated inside the chamber.

10. The apparatus of claim 1 wherein chamber is substantially airtight except for the hole.

11. The apparatus of claim 1 wherein the chamber comprises a plurality of sidewalls, wherein the hole is formed in a first sidewall of the chamber, the first sidewall comprising a pipe extender extending from the first sidewall of the chamber to increase a length of the hole.

12. The apparatus of claim 1 further comprising an AC plug extending through a sidewall of the chamber, wherein the hole is configured on the same sidewall as the AC plug so that an external surface is adjacent to a distal end of the hole when the AC plug is inserted into an AC power outlet.

13. The apparatus of claim 1 wherein the chamber comprises one or more sidewall surfaces coupled to one or more sidewall surfaces of the pressure sensor.

14. The apparatus of claim 1 wherein the chamber further comprises a plurality of covered holes having different lengths or different cross sectional areas to produce different low pass filter bandwidths.

15. The apparatus of claim 14 wherein, initially, all the holes are covered holes, and wherein the hole is opened to produce a particular low pass filter bandwidth corresponding to a length and a cross sectional area of the hole.

16. The apparatus of claim 1 wherein the hole and the chamber are configured to low pass filter pressure variations at the input of the pressure sensor and filter out pressure variations above between about 0.1 hertz and 10 hertz.

17. The apparatus of claim 1 further comprising a shield to cover a distal end of the hole, wherein the shield is external to the chamber.

18. The apparatus of claim 1 wherein the pressure sensor comprises a first input and a second input, wherein the chamber is a first chamber and the hole is a first hole, and further comprising a second chamber coupled to the second input of the pressure sensor, the second chamber comprising a second hole, wherein the second chamber and the second hole combine with the first chamber and the first hole to band pass filter pressure variations sensed by the pressure sensor and filter out pressure variations above about 20 hertz and below 0.1 hertz.

19. A method comprising:
receiving electrical power through an AC plug extending through a sidewall of a case, the case comprising a chamber;
coupling an external pressure into the chamber through a hole in the chamber to produce an internal pressure, wherein the hole and the chamber are configured to low pass filter pressure variations filter out pressure variations above about 20 hertz;
sensing the internal pressure below about 20 Hz at an input of a pressure sensor, wherein the chamber is coupled to the input of the pressure sensor to control pressure variations at the input of the pressure sensor; and
wherein the hole is configured on the same sidewall as the AC plug so that an external surface is adjacent to a distal end of the hole when the AC plug is inserted into an AC power outlet, and
wherein the chamber is substantially airtight except for the hole.

20. An apparatus comprising:
a pressure sensor having at least one input;
a chamber coupled to the input of the pressure sensor to control pressure variations at the input of the pressure sensor, the chamber comprising a hole, wherein the hole and the chamber are configured to low pass filter pressure variations at the input of the pressure sensor and filter out pressure variations above about 20 hertz; and
an AC plug extending through a sidewall of the chamber, wherein the hole is configured on the same sidewall as the AC plug so that an external surface is adjacent to a distal end of the hole when the AC plug is inserted into an AC power outlet
wherein chamber is substantially airtight except for the hole.
